(19) United States
(12) Patent Application Publication
(10) Pub. No.: US 2006/0173637 A1
(43) Pub. Date: Aug. 3, 2006

(54) Method of compensating for a measuring error and an electronic arrangement to this end

(76) Inventor: Hans Evald Goran Martin, Delsbo (SE)

Correspondence Address: JOHN LEZDEY;SUITE 100, 140 MARCDALE BLVD., INDIAN ROCKS BEACH, FL, 33782, US

(21) Appl. No.: 11/349,454

(22) Filed: Apr. 18, 2006

(30) Foreign Application Priority Data
Aug. 10, 2004 (WO) PCT/SE04/01179

(51) Int. Cl. G01N 31/00

(52) U.S. Cl. 702/24

(57) ABSTRACT

A method and electronic arrangement for measuring errors with the aid of a gas sensor wherein a plurality of measurement valves occurring instantly during mutual sequential measuring cycles are detected. The electronic circuit arrangement has a plurality of circuit arrangements for compensating measurement errors wherein the measurements are affect with a gas sensor.

### FIELD OF INVENTION

The present invention relates generally to a method of compensating for a measurement error that occurs in an obtained measuring value or result, and then particularly to a compensation of such measurement errors as those that occur subsequent to a chosen calibration of a measuring equipment and that can be considered to be related directly to such small changes that occur during a time-wise long use or duration.

Measuring errors obtained when measuring the concentration of gases have been divided into the following categories, for reasons of a practical nature:

a. Systematic errors.

b. Errors of short duration.

c. Errors related to time-wise long use or duration and successive errors.

d. Pressure dependent errors.

In this regard, it is known that a Category “c” measurement error is dependent on measurement errors associated with Categories “a”, “b” and “d”, and that efforts to compensate for Category “c” measurement errors will preferably commence, fundamentally, for compensating measurement errors belonging to Categories “a” and “b” as described and exemplified in more detail hereinafter.

Thus, among other things, the invention is adapted for compensating for measurement errors that are dependent on the time-wise slow change of ingoing components within an electronic circuit arrangement and a gas cell with the use of calibrated measuring equipment, such Category “c” errors being designated “drift” errors in short in the following text, by way of simplification.

The method and the electronic circuit arrangement according to the invention is intended for use in gas measuring processes that are intended to establish the presence of a gas (or gas mixture) and/or a current concentration of a chosen gas (or gas mixture) with the aid of a gas sensor arrangement or gas measuring equipment.

According to the proposals, put forward in respect of the present invention, a gas sensor arrangement or measuring equipment of this kind is, in principle, comprised of a gas sensor arrangement, an arrangement which is connected electrically to or included in an electronic circuit arrangement and which evaluates the amount of gas present and/or the concentration of said gas, and includes a signal compensating circuit, such as a temperature compensating circuit arrangement among other things, and a signal processing circuit arrangement connected thereto electrically and including measuring means adapted for a compensated measuring result or value.

In principle, an application of the present invention need not be considered to be dependent on any particular type of gas sensor arrangement but the signals emitted by a gas sensor arrangement can be processed successively via said signal compensating circuitry and/or said signal processing arrangement or circuitry.

Thus, the invention relates to the use of an IR-sensor, which may be one obtainable from a number of commercially available IR-sensors (gas sensors that are based on the use of light rays or beams lying within the infrared frequency range) which can be used beneficially to establish the presence of and/or the concentration of different gases, such as hydrocarbons (HC), nitrous oxygen (N₂O), carbon monoxide (CO), carbon dioxide (CO₂), while using electronic circuitry for spectral analysis of received light rays in IR-detector or IR-detectors, such as pulsated light rays, emitted in the gas sensor from a light emitting means.

The present invention may also be applied in electrochemical cells or sensors which can be used beneficially in establishing the presence of and/or the concentration of different gases, such as oxygen gas (O₂), ammonia (NH₃), ozone (O₃) and which give an increasing or decreasing voltage, depending on the existing gas concentration.

There can also be used semiconductor sensors, which may be based on MOS-technology for instance, where a surface reaction increases or decreases the surface conductivity that can be converted to a voltage or a voltage pulse or voltage pulses, depending on the prevailing concentration.

Thus, the following description will be limited to a specific gas sensor arrangement, making use of a specific IR-sensor solely for simplification, in order to be able to show clearly the properties of the invention with the aid of known spectral analysis.

A gas sensor arrangement or measuring equipment of this kind shall include a gas cell, or a gas sensor, that includes a cavity in which a gas volume to be measured can be enclosed, a light source, which is assigned to or related to said gas cell or sensor and which is intended to emit pulsated light rays or light beams through said cavity at a frequency within the IR-range, at least one light receiver, which is assigned to or related to said gas cell or sensor and which is intended to receive said pulsated light rays or light beams subsequent to said light rays having passed through a chosen “measuring distance or path” in said cavity, and electronic signal processing circuitry, connected to said gas cell or gassensor, and including electronic signal adaption circuits (said electronic circuitry being designated signal-compensating circuitry).

Such relatively complicated signal-compensating circuitry includes one or more electronic circuits which can be connected directly to said light source and to said light receiver in the case of this application of the invention, and which are adapted, among other things, to be able to evaluate the light intensity with regard to wavelengths included in the IR-range and related to pulsated light rays or light beams emitted by the light source, and to be able to evaluate the wavelengths related to the light intensity of one or more pulsated light rays or light beams received by the light receiver and accordingly determine and calculate respectively the presence of one or more gases and/or gas mixtures and/or the concentration of said one or more gases or gas mixtures.

In respect of the IR-sensors chosen it has been proposed to allow the pulse source to emit pulsated IR-beams, via a spectral analysis evaluating arrangement and associated signal-compensating circuitry with its means for compensating measuring results or values, such as to enable the pulse delay time to be varied according to the chosen environment.

The present invention finds application in electronic circuitry, connected to its associated gas cell or sensor, adapted to receive from the gas cell information, such as optical or opto-electrical information-carrying, signals, that is dependent on an instant measurement magnitude, wherein the optical or electrical signal may be increasing (or decreasing) depending on changes occurring in the measurement magnitude. In respect of the exemplifying embodiment, this is the case when concerned with evaluating the instant concentration value of a gas or a gas mixture.

The electronic circuit arrangement or the signal-compensating circuitry is thus adapted, among other things, to establish the presence of and the value of a measurement magnitude and an occurring measurement error or a measurement error related to said magnitude with the aid of electronic circuits related to said signal-compensating circuitry, and therewith create chosen and adapted compensation of different measurement errors in several stages, among other errors those that are related to the error source “drift” either completely or partially.

Of the error sources listed above and categorised as “a”, “b”, “c,” and “d” it will be noted that;

(Category “a”) Systematic Errors.

Those errors are normally stationary and do not vary, or only insignificantly vary, with time.

This type of error may be caused, for instance, by placing the gas sensor arrangement and its gas cell in an environment which lies outside the particular environment that is applied when calibrating the measuring equipment, or by errors that occurred in connection with a calibration of said equipment, or because said calibration was done wrongly, or because a wrong calibration gas was used, or because changes occurred during transportation and handling of the equipment.

Any temperature compensation may also fall within Category “a”.

(Category “b”) Errors of Short Duration.

These errors are normally sporadic and that vary over short time periods. This type of errors may be caused by the inherent noise of the sensor system as its electronic circuit arrangement and related gas cell construction, abnormal electrical disturbances, electrical transients, changes in chosen stability conditions, for example.

(Category “c”) Errors Related to Time-Wise Long Use or Duration and Successive Errors, Related to “Drift”.

These errors are normally caused by an “ageing” of discrete components and/or electronic circuits and are therefore difficult to establish and to compensate for.

The difficulties experienced in this category will be greatly dependent on the degree of compensation achieved in Categories “a” and “b”.

When using known technology, this means that the measuring system used for gas measurement and the measurement of gas concentration must, in practice, be re-calibrated at given relatively short time intervals, in order to ensure and guarantee a given chosen measurement accuracy.

(Category “d”) Pressure Dependent Error.

In order to be able to compensate for measurement values, produced in accordance with a prevailing pressure different from the pressure used during a calibration sequence, it is necessary to provide a pressure detecting sensor for each piece of measuring equipment.

The measuring equipment is calibrated while taking normalised air pressure into account. However, in the absence of pressure detecting sensors, no compensation is normally made on following measuring occasions.

### BACKGROUND OF THE INVENTION

Several different methods and arrangements of the aforesaid kind adapted for the aforesaid gas measuring application are known to the art.

Thus, it is known that the measurement magnitudes, obtained with instantaneous and/or mean-value-forming measurements of different kinds, will be in error to a greater or lesser extent, and that these measurement errors related to a measured value can be divided into a number of different error sources, as described above, and will therefore be more or less dependent on different circumstances related to different criteria connected to the measurement magnitudes concerned.

For example, it is known to insert one or more compensation factors into the electronic signal processing circuite arrangement used, so as to be able to compensate for errors that are directly foreseeable.

In this respect, it has been proposed to include directly to said signal processing circuit compensation factors for ambient temperature changes, ambient humidity changes and corresponding criteria that create errors of short duration.

In the case of the afore described special application of the present invention and the gas measurements associated therewith while using a gas cell or sensor and different electronic circuit arrangements for determining the presence of one or more gases and/or gas mixtures and/or calculating the concentration of said gas or gas mixture, it is known to calculate the measurement values electronically and also that these values can have greater or smaller discrepancies in relation to the “true” values applicable to the concentration of the gas in the gas cell cavity.

Such discrepancies are normally related to one or more of the error sources categorised and listed above, under Categories “b” to “d”.

With regard to Category “a”, Systematic errors these errors may also be related to the pressure, temperature, humidity prevailing ambient on the measuring occasion and also to other physical conditions prevailing around the gas cell or sensor and then particularly to the environmental circumstances around the gas cell sensor and its cavity, including mechanical influences brought about during transportation and the installation phase.

This category of error sources may also include such errors as those that vary slightly in time and that are therewith compensated for in accordance with the directives of the invention.

With regard to Category “c” Errors related to time-wise long use or duration, i.e. errors that are related to the error source designated “drift”, these errors are primarily considered as so-called “age-related” changes in the gas sensor arrangement, its gas cell or sensor and the electronic signal processing circuitry or circuit arrangements used.

When using IR-sensors, the Category “c” error source also includes, among other things, the gradual reduction in the ability of the cavity in the gas cell or sensor to reflect light rays, an impaired change in the ability of the light source to send continuous light rays or pulsated light rays at a chosen intensity, an impaired change in the ability of one or more light receivers to receive and evaluate the emitted, reflected and received light rays, such as pulsated light rays.

These latter Category “c” error sources also include a gradual change in chemical influences, gradual impairment related to increasing particle concentrations on light reflecting surface parts in said cavity, a change in voltage supply due to ageing of constant current and/or constant voltage regulating circuits, and changes occurring in the amplifying circuits used.

According to the present invention, the measuring errors related primarily to this latter type of Category “c” error sources can be compensated for subsequent to calibration.

For example, there are known to the art a number of different methods of correcting calculated measurement values carried out in a Non-Dispersive InfraRed (NDIR) gas cell, with the intention of compensating for and reducing the errors in calculated measurement values relating to the error source designated “drift”.

The U.S. Pat. No. 5,347,474 discloses a number of known methods for attempting to solve the problem concerning non-compensated measurement results deriving from “drift” error sources and where the problem is presumed to be manifest in IR-sensors (infrared) in general and in particular in IR-sensors adapted to evaluate the concentration of air-carried carbon dioxide and which can be used beneficially as fire detectors and also for controlling ventilation systems.

These and other known gas sensors are particularly adapted for use over long periods of time and are therewith maintenance free in principle.

The aforesaid US patent publication proposes, to this end, a gas sensor arrangement that includes a gas cell or sensor, and an electronic circuit arrangement for producing and storing mutually sequential measurement values in a memory.

One of the measurement error compensating methods, illustrated and described in this case, refers to the error source “drift” and is based on cyclically measuring and storing carbon dioxide values “X”, that occur within a known time interval and even within a known range.

This range is limited to a chosen low value, referenced “X_{L}”, and a chosen high value referenced “X_{H}”.

Used sensors are intended to produce an electric signal “x(t)” representing the prevailing value “X” related to the time (t).

The method is based on the ability to establish, when the value “x(t)” is located within the given range, and to sample the value “x(t)” during each time cycle when said value “x(t)” is located within said range (“X_{L}; X_{H}”) and, in addition, to store a representative “quiescent” value for each cycle.

From these stored measurements of gas concentrations obtained is evaluated and calculated a “straight line” function, which represents a function of the detected, calculated and stored “quiescent” values.

The above mentioned patent publication is based upon the condition that only NDIR-gas sensors are used.

To the prior art relates also the content of patent publication WO-A1-02/054086.

This patent publication shows and describes a method for compensating for “drift” within a gas sensor equipment, where data related to the gas concentration is sensed and stored during a chosen long time period and identify a low gas concentration level within the chosen time period.

The method is adapted to compare gas component concentrations, appearing under this low concentration level, with one or more additional gas component concentrations appearing under other low concentration levels and based upon is these conditions a background concentration is evaluated and may be related to further time periods with low concentration levels.

This calculated and estimated background concentration will then be used as a “reference value” or an expected (predicted) background gas concentration value and hereby forms the conditions for a correction factor or a desired or correction value.

For a base line operation such a correction value may represent a discrepancy between the background gas concentration value and a predetermined background gas concentration value.

For a “SPAN-constant” (described hereinafter) a correction value may be represented by a relation between the calculated background gas concentration value and the predetermined background gas concentration value.

Measured gas concentration values via a used gas sensor may be compensated for by using said correction value or factor.

This compensating method is based on evaluating the background gas concentration value over periods of time, where the periodicity is at least 24 hours but may extended up to 14 calendar days, so as to obtain a large number of measurement values of the background gas concentration over said period so as to process and therewith calculate a reference or desired value and a correction factor for the next following measurement period.

The production of these reference or desired values and correction factors related thereto thus requires significant computer power and gives fresh reference values for future measuring processes time upon time, with time periods of equal or different duration.

Moreover a theory of calibration has been suggested, using the basis for gas sensing through spectral analysis, which is based upon detecting the amount of absorbing light, within just a small spectral region that coincides with the resonance wavelength of the specie selected.

This technique is based upon a measure of a number of molecules of the particular specie, free from interference of other species.

Well known properties of a NDIR gas cell and its electronic circuit arrangement for gas detection are:
a. high selectivity—free from cross-interference,
b. sensitive & accurate,
c. environmental resistant,
d. able to put on stock over long time periods,
e. no over-exposure problems (no negative memory effects or exposure hysteresis),
f. described by relatively simple physics (predictable).

Moreover it is known to the art that the “Lambert-Beer's” law or formula describes the relation between resonant absorption “A” and a gas concentration “c”.
I_{d}=Iₒe^{-cds}
where “A”=(Iᵢ−I_{d})/Iᵢ.
“Iₒ” is the incident light intensity, “I_{d}” is the transmitted light intensity, “d” is the optical path length and “s” is the transition strength of the observation wavelength (a gas specific quantum mechanical constant).

In a typical NDIR gas cell or sensor an active IR light source is used to assure a high level of incident IR light flux “I_{d}” onto a light receiver or a photo detector. For a given geometry “d” fixed only two parameters “Iₒ” and “s” remains to establish before this formula can be used to experimentally determine the gas concentration “c”.

In practice this is done using two step calibration procedure, where “Iₒ” is determined first.

This first step is called the zero calibration, since it is preformed by filling the gas cell and its optical path with a “zero-gas”, where c=0

Vacuum may be used here but for practical reasons nitrogen, at atmospheric pressure, is more commonly used as a buffer gas (Nitrogen has no IR absorption). It is also proposed the use of a chemical absorber.

The second calibration step, needed to solve the remaining unknown parameter “s”, is called the SPAN calibration and involves the exposure of the optical path to a gas mixture with a known concentration “c”.

Thereafter Lambert-Beer's law, mentioned above, may theoretically be applied to measure “c” at any value.

It is to be noted that a SPAN calibration constant is closely related to the physical constant found in the exponent of the formula or law mentioned above and hence it is not expected to change with time for one and the same sensor construction, which is unfortunately not the case for a zero calibration constant.

The following description over the present invention is using “SPAN constant” and “O-constant”.

### SUMMARY OF THE PRESENT INVENTION

Technical Problems

When taking into consideration the technical deliberations that a person skilled in this particular art must make in order to provide a solution to one or more technical problems that he/she encounters it will be seen that on the one hand it is necessary initially to realise the measures and/or the sequence of measure that must be undertaken to this end and on the other hand to choose the means required to solve one or more of said problems. On this basis, it will be evident that the technical problems listed below are highly relevant to the development of the subject of the present invention.

When considering the present state of the art as described above, it will be seen that a technical problem in respect of a method and an electronic circuit arrangement related to a gas cell or sensor arrangement lies in the ability to realise the significance of, the advantages associated with and/or the constructive measures required in creating conditions that enable ready calculation of “true” measurement values, that can be connected to instant or existing measurement values received over long time cycles, and therewith enable measured magnitudes to be compensated for from one time cycle to another time cycle, among other things in respect of measurement errors related to such an error source as the “drift” error source.

In respect of compensating for measurement values related to “Category c”, a technical problem resides in the ability to realise the significance of, the advantages afforded by and/or the technical measures that shall be taken by introducing said compensation as a compensation factor for “Category a”.

A technical problem also resides in the ability to realise the significance of, the advantages afforded by and/or the technical measures required to advice a method and an electronic circuit arrangement causing a compensation for measurement errors, primarily measurement errors included in the “drift” error source, with the aid of a gas cell or sensor, wherewith a plurality of measurement values occurring instantaneously during mutually sequential measuring cycles are detected, wherein;
a. storing a lowest or a highest measurement value or a measurement value close thereto, occurring and evaluated during a chosen time period (T1) in a memory;
b. comparing said occurring and evaluated measurement value at the end of said chosen time period with a stored control value or set-point value;
c. using a discrepancy between the evaluated and occurring measurement value with said stored control value as a basis for a related and/or corresponding compensation of measurement values, obtained and occurring in a following time period (T2) and by;
d. using a temperature sensing means, related to a gas cell or gas sensor, which generates a signal corresponding to the prevailing temperature, whereby said signal is feed to an electronic circuit arrangement, and thereby cause conditions where a signal from a gas cell related sensing means, duly received by said arrangement, is used to cause a gas cell temperature depending correction of each received signal from one or more light receiving means, each also related to said gas cell.

It is also considered as a technical problem to realise the significance of, and the advantages afforded by and/or the technical measures required in that said temperature depending correction may be caused by a coordination of one or a few number of temperature depending data, related to one and the same reference point.

It is also considered as a technical problem to realise the significance of, and the advantages afforded by and/or the technical measures required in that said electronic circuit arrangement may include two circuits or the like, for causing two different signals, one representing light received pulse signal, one representing temperature, said signals may be represented by A/D-converted signals.

It is also considered as a technical problem to realise the significance of, and the advantages afforded by and/or the technical measures required in that one of two independent signals shall be related to a measurement value and the other signal is related to a temperature value inside or adjacent said gas cell and its cavity.

It is also considered as a technical problem to realise the significance of, and the advantages afforded by and/or the technical measures required in that a signal, related to said temperature, is used for a first required temperature compensation and in need for a second temperature compensation for further accuracy.

A technical problem also resides in the ability to realise the significance of, the advantages afforded by and/or the technical measures required to utilise a setting or a count number of an A/D-converter, such as at a normalised “0-constant” as a reference for a compensation factor.

A technical problem also resides in the ability to realise the significance of, the advantages associated with and/or the technical measures necessary in choosing a reference value on the basis of a calibration table or calibration curve, where said reference value may be related to a normalised CO₂ value (400 ppm), chosen lower than the value representing the A/D-converter setting at zero ppm (0 ppm), and therewith be able to create or cause a correcting calibration above or beneath a thus chosen reference value.

A technical problem also resides in the ability to realise the significance of and the advantages associated with the creation of conditions, with the aid of automatically producing compensation factors related to a time cycle, for a considerable lengthening of the active time period existing at that moment in time, for instance by a power of 10.

Another technical problem resides in the ability to realise the significance of and the advantages afforded by providing a method and a gas sensor arrangement with which the electronic circuit arrangement used can be readily adapted to find, establish and evaluate, in accordance with a chosen measurement magnitude, from signals from a chosen gas cell or sensor etc., a smallest or a greatest measurement-cycle-related or Ume-cycle-related correction measurement value, which, subsequent to cycle periods, can be related to a chosen desired or control analogue value and/or a control data-related value obtained via an A/D-converter and its outgoing signal.

Another technical problem resides in the ability to realise the significance of and the advantages associated with utlising to this end a measuring-cycle related or time-cycle related measurement value, which is connected directly to a smallest or a greatest reference-serving measurement value, or lies close to said smallest or said greatest reference-serving measurement value.

A technical problem also resides in the ability to propose measures that will significantly reduce the measures required in establishing compensation factors in methods and arrangements described above, such as the method described and illustrated in the aforesaid U.S. Pat. No. 5,347,474.

A technical problem also resides in the ability to create a single, usable digitalized and measurement-cycle related, measurement value with the aid of simple mathematical processes, such as a simple subtraction, addition, multiplication, division and/or a chosen algorithm, that can serve as a compensation factor, allotted to a following measurement cycle, primarily adapted for the “drift”-related error source.

More particularly, it will be seen that a technical problem resides in the ability to realise the significance of and the advantages afforded by storing successively in a memory each lowest, highest and/or analogue-digital measurement value related thereto, occurring and evaluated during a chosen time cycle, and with each occurring instantaneous measurement value, that is smaller than or slightly smaller than (or greater or slightly greater than), being identified as a stored measurement value in the measuring cycle and to replace a stored lowest measurement value with a new lower measurement value, and so on.

A technical problem also resides in the ability to realise the significance of and the advantages associated with comparing the measurement value, the lowest (or the highest) measurement value stored at the end of a chosen measurement cycle or time cycle, with a chosen desired or control analogue value or a desired or control value obtained via an A/D-converter related signal, where said control value may consist of a readily available desired or control value, such as the presence of a gas, a gas mixture and/or a concentration of an air-carried gas.

A technical problem also resides in the ability to realise the significance of and the advantages associated with utilising a comparison-revealed discrepancy between the evaluated and stored measurement value and said desired or analogue control value or said desired or control value obtained via said A/D-converter as a basis of compensation of measurement values related thereto and/or corresponding compensation of measurement values occurring within a complete following measurement cycle.

A technical problem also resides in the ability to create readily conditions that will enable an evaluated and occurring positive (or negative) discrepancy to be used more or less directly, to lower or raise evaluated and calculated measurement values, dependent on a chosen measurement magnitude, for compensation of expected corresponding errors related to the “drift” error source occurring in an immediately following measurement cycle.

It will also be seen that a technical problem resides in the creation of conditions in which the gas sensor arrangement can be calibrated forcibly, with the aid of simple manual measures, by subjecting the gas cell or the gas sensor to a chosen calibrating gas, at least at some period during a relevant measuring cycle.

A technical problem also resides in the ability to comprehend the significance of and the advantages associated with adapting said stored control analogue value or said control value obtained via an A/D-converter related signal to a gas concentration value representative of a corresponding gas concentration that normally occurs in ambient air, such as in non-contaminated air or air that has a gas concentration differing from non-contaminated air.

Another technical problem resides in the ability to realise the significance of and the advantages associated with adapting such a control value for carbon dioxide (CO₂) to a value that lies within a range of between 350-450 ppm.

A technical problem also resides in the ability to realise the significance of and the advantages afforded by allowing an allocated measurement cycle to have a minimised duration which is at least sufficiently long for probability evaluations to indicate that a measurement value connected to such a desired or chosen reference value will be able to appear, manually or automatically, once during said measuring cycle.

A technical problem also resides in the ability to realise the significance of and the advantages afforded by allowing an allocated measuring cycle to have a maximised duration, where “drift” conditions of the gas sensor arrangement render presentation of a measurement value particularly difficult.

A technical problem also resides in the ability to realise the significance of and the advantages associated with allowing a chosen degree of compensation for evaluated measurement values to be dependent on further criteria.

A further technical problem resides in the ability to realise the significance of and the advantages afforded by allowing a chosen degree of compensation, evaluated between mutually sequential measuring cycles, to be always below (or above) a pre-determined limit value.

Another technical problem resides in the ability to realise the significance of and the advantages afforded by storing a first freely generated measurement value, occurring in a measuring cycle in a memory as a first lowest measurement value, and to replace said stored first measurement value with a still lower (or higher) measurement value at the moment of its appearance and storing this latter measurement value in said memory as a second, lowest (or highest) measurement value, and so on.

Solution

The present invention takes as its starting point the known technology described in the introduction, comprising a method and an electronic circuit arrangement for compensating measuring errors primarily related to “drift” error sources in respect of measuring processes that utilise a gas cell or sensor of the kind given by way of introduction.

The method and the electronic circuit arrangement is adapted for compensating measurement errors, primarily measurement errors included in the “drift” error source, with the aid of a gas cell or sensor, wherewith a plurality of measurement values occurring instantaneously during mutually sequential measuring cycles are detected.

It is here suggested the principal of;
a. storing a lowest or a highest measurement value or a measurement value close thereto, occurring and evaluated during a chosen time period in a memory;
b. comparing said occurring and evaluated measurement value at the end of said chosen time period with a stored control value or set-point value and/or with a control value;
c. using a discrepancy between the evaluated and occurring measurement value with said stored control value as a basis for a related and/or corresponding compensation of measurement values obtained and occurring in a following time period and by;
d. using a temperature sensing means, related to a gas cell or gas sensor, which generates a signal corresponding to the prevailing temperature, whereby said signal is feed to an electronic circuit arrangement,

With the intention of solving one or more of the technical problems listed above it is particularly proposed, in accordance with the present invention, that the known technology as described above is enhanced with the step using a signal from a gas cell related sensing means and duly received by said arrangement and to use this signal to cause a temperature depending correction of each received signal from one or more light receiving means each also related to said gas cell.

It is also proposed as suggested embodiments that said temperature depending correction will be caused by a coordination of a number of temperature depending data, related to one and the same reference point.

It is also proposed as suggested embodiments that said electronic circuit arrangement shall include two signal receiving circuits or the like for causing two different signals relating to two different criteria.

It is also proposed as suggested embodiments that one signal is related to the measurement value and one signal is related to the temperature value.

It is also proposed as suggested embodiments that said signal, related to the temperature, is used in a first temperature compensation sequence and at need in a second temperature compensation sequence.

It is also proposed that this occurring and/or evaluated measurement value is compared with an analogue or digital reference or desired value stored in memories in the electronic circuit arrangement, designated desired or reference value hereinafter, or a desired or reference value produced through the agency of an A/D-converter related signal, at the end of the chosen measuring cycle.

Occurring discrepancies between the thus evaluated measurement value and said stored desired or reference value shall constitute a basis for related and/or corresponding compensation of all measurement values occurring in a following measuring cycle.

By way of proposed embodiments, that lie within the scope of the fundamental concept of the present invention, the evaluated measurement values to be compensated and occurring in an immediately following measurement cycle shall be lowered or reduced when the discrepancy is positive, or increased when the discrepancy is negative or vice versa.

The stored reference value may be adapted to a chosen gas concentration, representative of a corresponding gas concentration, occurring in air, where a reference value for carbon dioxide (CO₂) can therewith be adapted to a value that lies between 350-450 ppm, such as 400 ppm.

According to the present invention a chosen degree of electronic compensation or an electronic compensation factor may be dependent on additional criteria.

The degree of compensation, evaluated between mutually sequential measuring cycles, is chosen to be at least lower than a pre-determined value.

A first measurement value, occurring in the measuring cycle, shall be stored in the memory as a first lowest measurement value (or a highest measurement value), this stored first lowest measurement value being replaced upon the occurrence of a still lower (or a higher) measurement value, this latter measurement value being stored in said memory as a second lowest (or highest) measurement value, and so on.

Advantages

Those advantages primarily afforded by the present invention and the special significant characterising features of the invention are obtained by the creation of conditions with which a correction value or a correction factor, that can be used for analogue or digital and temperature related compensation of a measurement error, can be determined more easily, said error being related, among other things, to the “drift” measuring source when measuring magnitudes through the agency of a gas cell or a sensor.

At the end of each measuring cycle it is possible to obtain an automatic calibration of the measuring result obtained from the gas cell or sensor in a subsequent measuring cycle, with the aid of a simple algorithm with which there can be obtained a readily available desired value used as a desired or reference value, which may be conveniently obtained through the medium of an A/D-converter and a signal related thereto.

The primary characteristic features of a method, according to the present invention, are set forth in the characterising clause of the accompanying claim 1, while the primary characteristic features of an electronic circuit arrangement, according to the present invention, are set forth in the characterising clause of the accompanying claim 15.

### BRIEF DESCRIPTION OF THE DRAWINGS

Two embodiments at present proposed and comprising significant characteristic features associated with the present invention will now be described by way of example with reference to the accompanying drawing, in which;

FIG. 1 is a block diagram illustrating in principle a gas sensor arrangement, which uses IR-beams and which includes a gas cell, that has a light source and two light receivers connected to an electronic circuit arrangement, having associated electronic circuitry and a display unit;

FIG. 2 is a block diagram illustrating an electronic circuit arrangement having electronic circuits and functions which mutually co-act in accordance with the directives of the present invention and which are adapted to establish a “lowest” measurement value during a measuring cycle using analogue technique;

FIG. 3 is a graph that illustrates a time-wise variation of carbon dioxide (CO₂) concentration in a well delimited space;

FIG. 4 is a general sensor graph, according to FIG. 3, showing a plurality of mutually sequential measuring cycles, where an evaluated measurement error, significant of the present invention, can be achieved within a first measuring cycle in a time section occurring between two mutually orientated measuring cycles, and where a degree of compensation for measurement errors can be applied to each measuremet value within an immediately following measuring cycle;

FIG. 5 is a graph showing the output signal related to an A/D-converter as a function of the CO₂-concentration at two disparate measurements, taken at two different temperatures namely +5° C. and +50° C., where the count number received at a zero CO₂-concentration is of importance;

FIG. 6 is a graph showing two temperature compensated output signals as a function of the CO₂-concentration and where the compensation is so chosen that the two graphs exposes one and the same zero value, represented hereby the count number 61440;

FIG. 7 is a graph showing a calibration table for the output signal as a function of the CO₂-concentration, where the desired or reference value has been chosen to a value represented by a chosen value of 400 ppm, with respect to the CO₂-gas concentration and where a second temperature compensation may be used;

FIG. 8 is a block diagram illustrating an electronic circuit arrangement that has electronic circuits and functions that co-act with A/D-converters, in accordance with given directives of the present invention, and adapted to establish a “highest” measurement value during a measuring cycle while using an A/D-converter related signal (analogue-digital transforming signal) and where the electronic circuit arrangement is, in this case, adapted to signal processing of digital signals directly, and;

FIG. 9 is a graph showing the output signal related to said A/D-converter during a calibration sequence, equal to the graph shown in FIG. 5.

### DESCRIPTION OF EMBODIMENTS AT PRESENT PREFERRED

It is pointed out initially that we have chosen to use in the following description of embodiments at present preferred and including significant characteristic features of the invention and illustrated in the figures of the accompanying drawings special terms and terminology with the intention of illustrating the inventive concept more clearly.

It will be noted, however, that the expressions chosen here shall not be seen as being limited solely to the chosen terms used in the description, but that each term chosen shall be interpreted as also including all technical equivalents that function in the same or at least essentially the same way so as to achieve the same or essentially the same intention and/or technical effect.

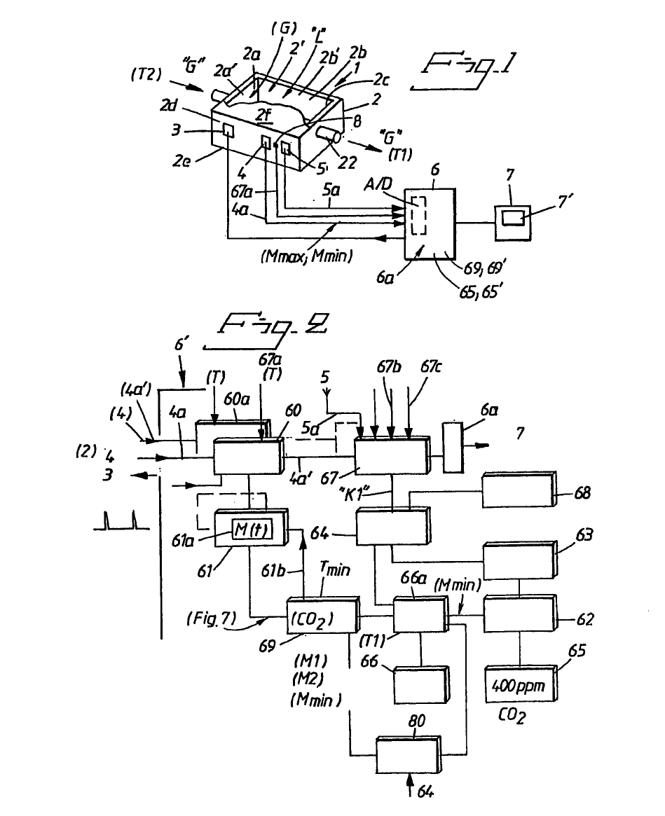

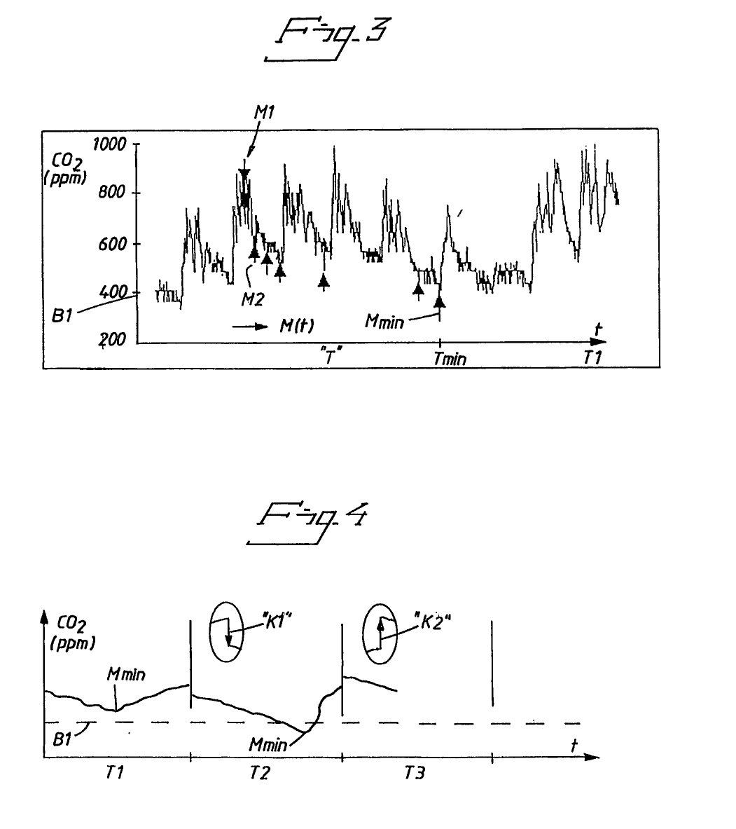

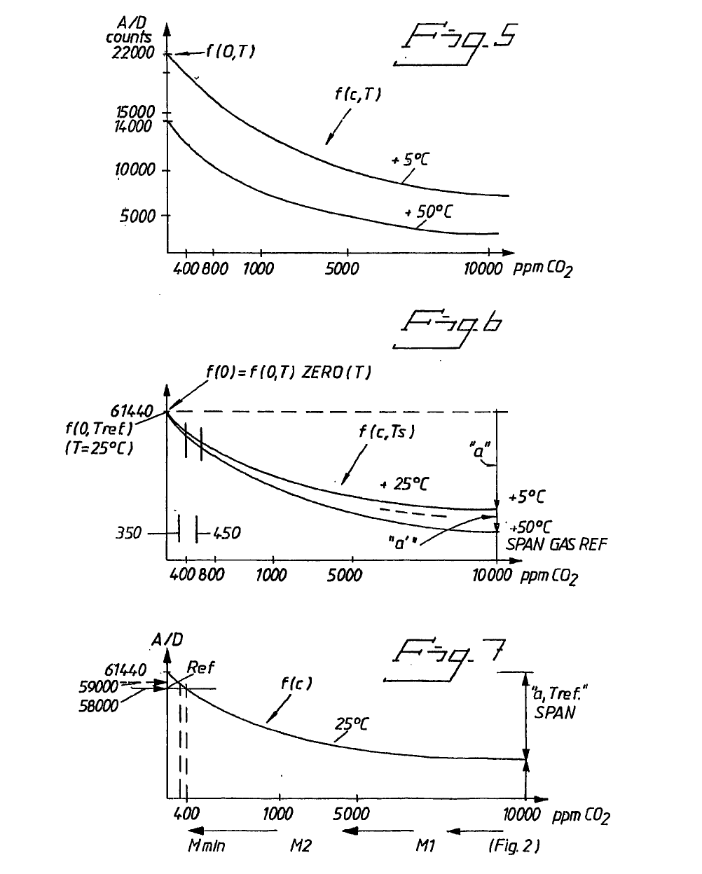

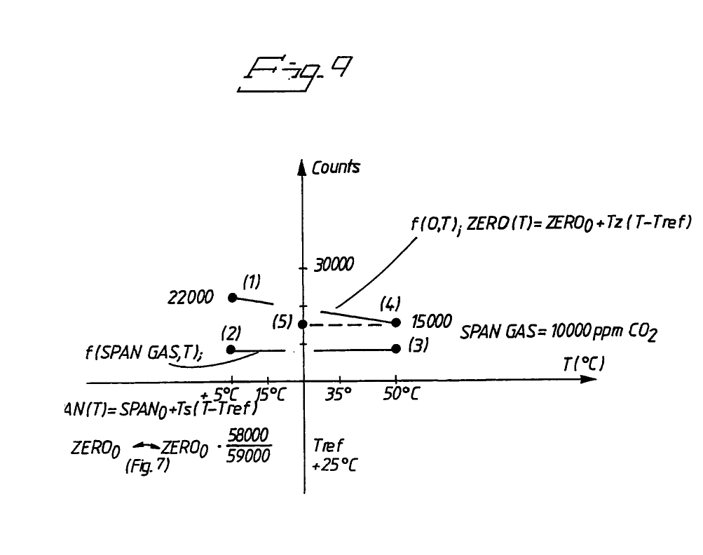

FIG. 1 illustrates diagrammatically the basic requisites of the present invention, wherein features significant of the present invention are generally concreted by virtue of proposed embodiments described in more detail hereinafter, one with reference to FIG. 2 and one with reference to FIG. 8.

The method according to the invention and the proposed electronic circuit arrangement are, in principle, independent of the sensor and the type of sensor used, although the following description is limited to the use of one type of gas sensor only.

The principle construction of one such gas sensor 1, shown in FIG. 1, is known to the art.

The invention can thus be based on the use of a gas cell 2 associated with the gas sensor 1 comprising a uniquely orientated light source 3 adapted to emit pulsated IR-light, and unique co-ordination of a number of light pulse receiving means, in the case of the illustrated embodiment two light receiving means or receivers 4 and 5 disposed side by side.

The person knowledgeable in this technical field will be aware that the number of light receivers 4, 5 may vary as can also their physical position, depending on the gas or gases chosen or on a chosen gas mixture and on the form of the cavity 2′ in the gas cell 2 and on a chosen “measuring distance or path”.

The following description of a proposed embodiment has been illustrated with reference to two side-related light receivers solely by way of simplification, where one light receiver 4 is placed and adapted for an absorption wavelength with an associated measuring distance corresponding to the gas chosen, while the other light receiver 5 is positioned and adapted to serve as a reference wavelength.

The present invention covers a method and an electronic circuit arrangement of compensating for measurement errors, primarily measurement errors included in the “drift” error source, with the aid of a gas cell or sensor, wherewith a plurality of measurement values occurring instantaneously during mutually sequential measuring cycles are detected.

The invention is based upon;
a. storing a lowest or a highest measurement value or a measurement value close thereto, occurring and evaluated during a chosen time period T1 in a memory 69, 69′;
b. comparing said occurring and evaluated measurement value at the end of said chosen time period T1 with a stored control value or set-point value 65, 65′;
c. using a discrepancy between the evaluated and occurring measurement value with said stored control value as a basis for a related and/or corresponding compensation of measurement values obtained and occurring in a following time period (T2) and by;
d. using a temperature sensing means 8, related to a gas cell 2, which generates a signal corresponding to the prevailing temperature, whereby said signal is separately feed to said electronic circuit arrangement 6.

It is here suggested that a signal on a line 67a from a gas cell 2 related temperature sensing means 8 and duly received by said arrangement 6 is used to cause a temperature depending correction “K1” of each received signal from one or more light receiving means 4, 5, each related to said gas cell 2.

The temperature sensing means 8 and the used light receiving means 4, 5 are arranged adjacent each other in a wall section of the gas cell 2 and on the inside of the cavity 2′.

More precisely said temperature depending correction is caused by a coordination of a number of temperature depending data related to one and the same reference point.

Said electronic circuit arrangement 6 or 6′ includes two circuits or the like for causing two separated signals, one signal related to and represents the measurement value, and one signal related to and represents the temperature value.

In the FIG. 2 embodiment these two circuits are included in an electronic circuit 60 and in FIG. 8 embodiment these two circuits are included in an electronic circuit 60′ and here illustrated as two separated or functionally combined A/D-converters.

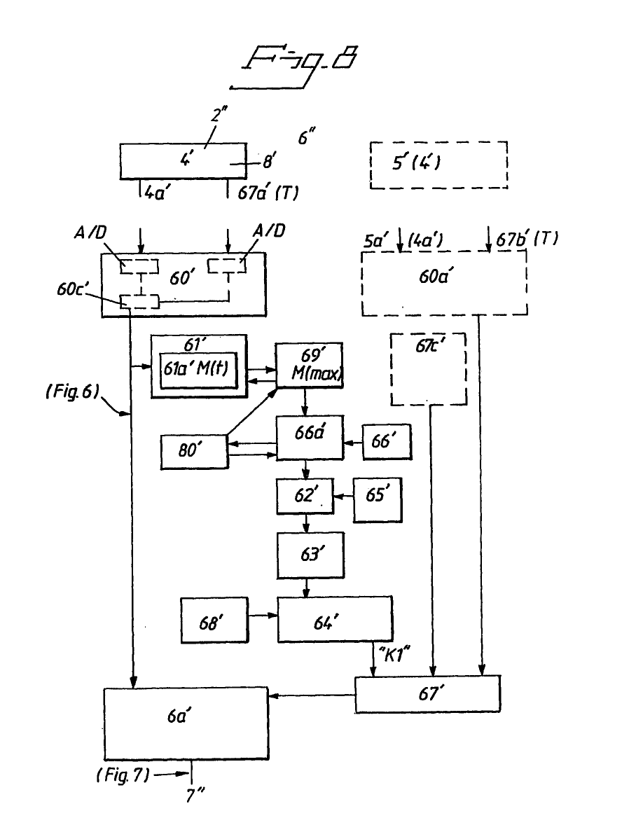

In the embodiment illustrated in FIG. 8 the signal, related to the temperature, may be used for a first temperature compensation (FIG. 6) and by need for a second temperature compensation (FIG. 7).

With the aid of said electronic circuit (60 in FIG. 2; 60′ in FIG. 8) that receives signals from only one light receiver 4, the output signals can be normalised so as to be generally independent of any varying light intensity from the light source 3.

As shown in FIG. 1, the gas cell 2 includes to this end a cavity 2′ that has light reflecting properties and that is delimited by mutually opposed wall portions, said cavity being defined diagrammatically by a first side-related wall portion 2a, a second side-related wall portion 2b, a third side-related wall portion 2c and a fourth side-related wall portion 2d.

The side-related wall portions 2a, 2b, 2c and 2d co-act with a flat bottom portion 2e and a flat ceiling portion 2f that extend parallel to one another.

The wall portions or wall surfaces 2a, 2b, that have been treated to provide light reflecting properties, are referenced 2a′, 2b′, etc. and are designated “mirror surfaces” 2a′, 2b′, etc., in the following description.

In principle, a continuous light beam “L” or in the illustrated case a pulsated light beam “L”, emitted from the light source 3 shall pass the cavity 2′ and be readily reflected by a single wall surface or mirror surface 2b′ and directed towards and received by the light receiver 4 (or 5) in a known manner, therewith travelling a “measuring distance or path” inside this cavity 2′.

The light beam “L” therewith defines a cavity-enclosed “optical measuring distance or path” passing through an enclosed gas sample (G).

Different gases and different gas mixtures require optical measuring paths of different distances, which can be provided by enlarging the dimensions of the cavity 2′ or by creating conditions for a plurality of reflective parts or reflective points, arranged between the light source 3 and a respective receiver 4 and 5.

Thus, FIG. 1 shows a gas cell 2 through which a gas “G” can flow and which will include a gas sample (G) for electronic evaluation.

The gas cell 2 used in the FIG. 1 illustration is adapted to co-act as a unit with electronic circuits contained in an electronic circuit arrangement 6 by means of which the light source 3 of a gas cell or a gas sensor can be driven and signals occurring on one or more light receivers 4, 5 can be detected (sensed) and therewith enable evaluation of the instant light intensity, related to a chosen absorption wavelength or wavelengths or related to a chosen reference wavelength or reference wavelengths, and depending thereon electronically evaluate the presence of a chosen gas “G” and/or calculate the concentration of such a gas through the agency of known spectral analysis.

A display unit or corresponding circuit 7 is connected to the electronic circuit arrangement 6 for visual display on a monitor or image screen 7′ or to indicate in some other way solely the presence of a gas and a measurement value relating to the concentration of the gas present.

It is known in the case of gas sensors 1 of this particular kind that the current value of the gas concentration in the cavity 2′ or the gas sensor 2 is represented by an analogue voltage value, which can be presented on the display surface 7′ via signal processing in the electronic circuit arrangement 6, or can be used directly by process controlling circuits, and that the illustrated measurement value can be in error, derived from one or more error sources, mentioned hereinbefore.

The present invention is based on allowing the electronic circuit arrangement 6 to process electric signals incoming from a chosen sensor (a light receiver 4 or several light receivers 4 and 5) such as to form an analogue measurement value and to be able to analogue compensate for occurring measurement errors so that the output signal of the electronic circuit arrangement 6 will represent the prevailing and “true” value of the gas concentration with the smallest possible discrepancy, when said value is shown on the display surface 7′ or used in some other way.

Shown in FIG. 2 is an electronic circuit arrangement 6′, which, according to the invention, is at least able to compensate for those measurement errors related to the “drift” error source.

It will be particularly noted that the embodiment, according to FIG. 2, with reference to FIGS. 3 and 4, shall control towards a lowest gas concentration value, whereas an embodiment according to FIG. 8, with reference to FIGS. 5, 6, 7 and 9, shall control towards a “highest” numerical value, related to the output signal depending on the use of an A/D-converter.

The embodiment shown in FIG. 2 has been illustrated with analogue values, while the embodiment shown in FIG. 8 has been illustrated with digital values, this latter while using an analogue signal to digital signal converting circuit, hereinafter designated as an A/D-converter (A/D).

FIG. 2 is a block diagram illustration of an electronic circuit arrangement given the reference numeral 6′, with which received analogue signals can be processed in a manner to compensate the measurement value of those measurement errors related to the “drift” measurement error among other things.

Thus, FIG. 2 includes a block diagram illustration of the electronic circuit arrangement 6′ that includes a number of electronic circuits and functions, each represented by a block, and it will be evident that these blocks can be formed as electric or electronic circuit arrangements or as software, in order to execute their functions via computers.

For the sake of clarity, FIG. 2 also shows a signal receiving circuit 60, which is connected directly to a chosen gas sensor 2.

The illustrated embodiment also includes a connection 4a to a gas cell or sensor 2 associated light receiver 4.

A circuit 60a is or may be connected to another gas cell or sensor, such as to another gas sensor associated light receiver (4) via a line (4a′) or the light receiver 5.

Because the electronic circuit arrangement 6′ applicable to the circuit 60 is more or less identical to the electronic arrangement intended for the circuit 60a, solely the circuit 60 will be described in the following description by way of simplification, said circuit 60 being connected to the light receiver 4 by a line 4a and to the means 8 by a line 67a.

The electronic circuit arrangement 6′ thus includes a circuit 60 for receiving pulsated analogue signals emitted from the gas sensor 1.

The signals on the line 4a will depend on the type of gas sensor used and also on the nature of what is to be measured.

Since the light receiver 5, in FIG. 1, shall serve as a reference signal, the output signal on a line 5a may be connected to a circuit 67, whose function will be described in more detail in the following text.

In the case of gas sensors of the kind, illustrated in FIG. 1, the concentration of a carbon dioxide gas (CO₂) in relation to fresh air will increase above the value afforded by fresh air, while the oxygen content (O₂) will decrease in relation to contaminants entered.

The exemplifying example, shown in FIGS. 1 and 2, and in FIGS. 3 and 4, are thus concerned with an increase in the carbon dioxide content of contaminated air above the carbon dioxide value applicable to fresh air.

In connection with this assumption, FIG. 3 illustrates a graph that shows a time-wise variation of the carbon dioxide concentration within a delimited, although ventilated, space.

The structure of the signal from the gas sensor receiver 4 is thus shown in FIG. 3 and is received in the circuit 60 as an analogue signal.

Co-acting with the circuit 60 is a first circuit arrangement 61, which notes each occurring low value or lower value, with regard to the carbon dioxide concentration in a measuring cycle designated “T1”.

The circuit arrangement 61 also includes a circuit set-up 61a, which is adapted to take into consideration solely those measurement values “M(t)” that fulfil certain quality criteria.

The circuit set-up 61a will therewith take into consideration available status information regarding measuring of other physical parameters, such as the prevailing or current drive voltage.

The circuit set-up 61a will also take into consideration different stabilising conditions and will therewith accept solely the measurement values that are obtained when the measuring situation is in a “quiescent” state.

This consideration also includes the effect of electric transients, sabotage control, and the like.

The circuit arrangement 61 is informed, via a line 61b, of the lowest carbon dioxide value stored in a memory 69, and the value (CO₂) stored in the memory 69 is replaced with a new, still lower value, immediately when it occurs, in the circuit arrangement 61a, thus a carbon dioxide concentration value that is below the value already stored in the memory 69 is entered into the memory 69.

The circuit arrangement 61 detects sequensially occurring low carbon dioxide values during the entire measuring circle “T1”, and replaces each higher value stored in the memory 69 with a lower value.

In this regard, FIG. 2 shows that at the beginning of the measuring cycle “T1”, a first carbon dioxide value (M1) is stored in the memory 69 and is replaced by a second lower value (M2), which, in turn, is replaced with a last or lowest value (Mmin).

It is assumed that the measuring cycle “T1” is of such reasonable duration as to be probable that reference air, with its correct carbon dioxide value, will be present over a short period of time and that there is good basis for the assumption that the lowest carbon dioxide concentration measured during the measuring cycle “T1” is precisely the carbon dioxide concentration applicable to the reference fresh and ambient air.

This lowest value (Mmin) shall be compared with a stored reference value or a stored desired value.

In accordance with the graph, illustrated in FIG. 3, a lowest measurement value “Mmin” occurring and evaluated during a chosen time period or measuring cycle “T1” shall be stored in the memory 69 via said first circuit arrangement 61.

The graph shown in FIG. 3 is cyclic to a certain degree, inasmuch as the carbon dioxide concentration CO₂ increases during the day when people occupy a more or less closed locality, and falls-off during the night. The carbon dioxide concentration is also low on Sundays.

The lowest measurement value (Mmin) occurring, evaluated and stored at time point “Tmin” shall be transferred at the end of the measuring cycle “T1” to a second circuit arrangement 62, via the time circuit 66a, in which the measured value is compared with a reference value or desired value entered into and stored in a fifth circuit arrangement 65.

The desired value in the fifth circuit arrangement 65 is set to a value of say 400 ppm, corresponding to the carbon dioxide concentration of fresh air.

The second circuit arrangement 62 now establishes the magnitude and the sign (“+” or “−”) of the discrepancy, via subtraction or some other analogue function.

The evaluated discrepancy is received in a third circuit arrangement 63 at the end of the measuring cycle “T1”.

Used factors and received raw data are considered in the third circuit arrangement 63 with the intention of forming there, from a factor or a function that shall be coordinated with raw data occurring on the line 4a and the line (4a′), a compensation of a measurement error in a following measuring cycle “T2”.

Thus, there is formed in the third circuit arrangement 63 the basis on which the measurement values occurring in an immediately following measuring cycle or time period, referenced “T2” in FIG. 4, and related and corresponding to said discrepancy can be compensated in a fourth circuit arrangement 64.

It can be assumed in principle that when a positive discrepancy occurs and is evaluated in the second circuit arrangement 62 and signal processed in the third circuit arrangement 63 and transferred to the fourth circuit arrangement 64 as a factor or a function, each evaluated measurement value for said compensation occurring in an immediately following measuring cycle or time period “T2” decreases, and vice versa.

Thus, the compensation value stored in the fourth circuit arrangement 64 constitutes a compensation value, compensation factor and/or compensation function applicable to each measuring value evaluated in a following measuring cycle “T2”, and, seen practically, is adapted, via said fifth circuit arrangement 65, to a virtual gas concentration represented by a reference-serving corresponding fresh-air gas concentration.

The desired or reference carbon dioxide control value shall thus be adapted via said fifth circuit arrangement 65 to a chosen value lying with in the concentration range of 350-450 ppm.

Other desired values or control values obtained for other gases and/or gas mixtures may, of course, be entered.

The measuring cycles “T1”, “T2” and “T3” chosen in the time circuit 66a shall be given an adapted duration through the agency of a sixth circuit arrangement 66.

In the case of building localities, such as schools, offices, shopping malls, said time period “T1” may have a duration of between 3 and 30 days, or calendar days when it is highly probable that measurement values corresponding to fresh air values will occur each night and each morning.

In the case of storage locations, beer cellars and other closed spaces, this time period or measuring cycle may have a duration of between 30 and 180 days.

In the case of closed container transport and/or CO₂-controlled maturing (ripening) transport, the time period can be set for between 50 and 60 calendar days.

In summary, it may be suitable in the majority of applications for the time period to exceed 3 days and be less than 30 days, such as longer than 5 days and shorter than 25 days.

The time duration chosen will depend on different requirements and conditions.

Thus, it is significant to the present invention that the external conditions with regard to the gas cell or the gas sensor 2 (or the gas “G”) shall be such that the occurring and measured gas concentration will fall to a value that is representative of a chosen desired value at some moment of time during the chosen measuring cycle “T1”, and that an occurring discrepancy, with respect to a pre-set desired value, shall serve as a compensation factor in a following measuring cycle “T2” and that a discrepancy established in the measuring cycle “T2” shall serve as a compensation factor in a following measuring cycle “T3”, and so on.

A compensation factor “K1”, calculated in the fourth circuit arrangement 64, is transferred to a seventh circuit arrangement 67 and stored therein so as to be able to compensate each occurring and time-related measurement value in the immediately following measuring cycle “T2”.

The total extent of compensation chosen, related to the raw data received, may, via said seventh circuit arrangement 67, also be dependent on compensation signals on the line 5a and further, normally brief, criteria related to compensation signals occurring on the lines 67b and 67c.

A chosen degree of compensation between two mutually sequential measuring cycles “T1” and “T2” is adapted to be less than a pre-determined maximised or minimised value via an eighth circuit arrangement 68, so as to enable the prevention of an excessively rapid and high correction that may be due to non-controllable errors.

Also shown in FIG. 2 is a start circuit 80 that can be triggered by the time circuit 66a and the fourth circuit arrangement 64 and its calculated correction factor “K1”, wherein the start circuit 80 inserts a first measurement value (M1) into the memory 69 and initiates the commencement of a second measuring cycle “T2”, via the time circuit 66a.

As before indicated, a second measurement value obtained in measurement cycles “T1” or “T2”, etc. is stored in the memory 69 as a second lowest measurement value “M2” via said first circuit arrangement 61, said stored second measurement value (M2) being replaced upon the occurrence of a still lower measurement value, which is therewith stored in the memory 69.

The measurement values (M1), (M2), etc. stored in the memory 69 will thus be replaced successively by new lower measurement values right down to the lowest measurement value “Mmin” occurring in the measuring cycle “T1”, the measurement cycle “T2”, etc. and stored as (Mmin). (In the case of an inverse function, the measurement values are stored against an “Mmax” value, which will be explained in more detail with reference to FIG. 8).

The lowest measurement value (Mmin) then remains in the memory 69 until the end of the measuring cycle “T1 ⇄ and is used as the sole reference to the set desired or control value in evaluating the relevant degree of compensation “K1” in respect of the next following measuring cycle “T2”.

The occurring lowest measurement values and the compensation to be effected at the transition from a first measuring cycle “T1” to a second measuring cycle “T2” is illustrated more clearly in FIGS. 3 and 4.

FIG. 3 is intended to show the analogue signal structure in more detail during parts of a measuring cycle “T1”, and illustrates the time point “Tmin” during which the lowest measurement value “Mmin” for carbon dioxide (CO₂) is measured.

FIG. 4 is intended to illustrate a graph of the analogue signal structure during a plurality of measuring cycles, in which the measurement value “Mmin” in respect of the measuring cycle “T1” slightly exceeds the set desired value “B1” (400 ppm CO₂) and that a calculated correction factor “K1”, which is intended to lower all measurement values during said following measuring cycle “T2”, is introduced in the time section between the measuring cycle “T1” and said measuring cycle “T2”.

With respect to the measuring cycle “T2” the measurement value “Mmin” compensated with correction factor “K1” is somewhat smaller than the set control value “B1” and consequently there is introduced at the time section between the measuring cycle “T2” and the measuring cycle “T3” a new correction factor “K2” for increasing all measurement values produced during the following measuring cycle “T3”, and so on.

The description illustrates an embodiment in which the natural carbon dioxide content of the air is used as a desired or control value. However, there is nothing to prevent the use of other gases, such as nitrogen gas, when the gas provides a control value that is equal to or close to zero or other references.

There will now be described with reference to FIGS. 5 to 9 inclusive an alternative embodiment of the invention that utilises a function conversion in relation to that shown in FIGS. 2-4 inclusive.

Shown in FIG. 5 is two graphs, related to a function designated “f(c,T)”, where “c” is representing a gas concentration and “T” is representing temperature, representing an output signal or calculated value obtained from an A/D-converter as a function of the CO₂-concentration in two different measuring processes, carried out at two different temperatures, so as to illustrate the requirement of a first temperature correction (See FIG. 6).

The zero-points or 0-points in FIG. 5 referred to the function “f(c,T)” has been given the reference f(O,T), 0-concentration.

FIG. 5 represents the calculated value (22000) of an A/D-converter in the absence (0) of CO₂-gas at +5° C., and the graph shows a corresponding value applicable to +50° C. and which can be estimated as being a calculated value of 14000.

FIG. 6 is intended to present two graphs of temperature-corrected output signals, where said temperature correction relates to the discrepancy given in FIG. 5.

More precisely FIG. 6 is intended to present two temperature compensated graphs “f(c,Ts)”, where “c” is representing a gas concentration and “Ts” represents a temperature.

This compensation is adjusted to that the two graphs are concentrated towards one and the same zero-value or 0-point, here given the A/D-related calculated value of 61440.

FIG. 6 illustrates the discrepancy between the temperature compensated graphs at +5° C. and +50° C., where the discrepancy is shown at maximum at a SPAN GAS REF (10 000 ppm CO₂).

More over the compensation is adjusted towards a fixed temperature value, here chosen as 25° C.

FIG. 6 illustrates an increasing discrepancy with increasing carbon dioxide (CO₂) concentration and the values received at higher concentration values (above 800 ppm CO₂) are surely stored but replaced by lower and lower concentration values.

Within the range 350-450 ppm CO₂ the discrepancy is so reduced that in some applications the first temperature compensation, as illustrated in FIG. 6, can be considered sufficient.

FIG. 6 also indicates that the absorption, designated “a” and “a”, is depending upon prevailing temperature.

FIG. 7 indicates a single graph, designated “f(c)” where the temperature depending absorption “a” and “a′” in FIG. 6 has been temperature compensated in a further compensation mode towards one and the same fixed temperature value, here chosen as +25° C., and the temperature compensated absorption has here been given the reference “a,T_{ref}”, which is related to a SPAN-value graph.

In FIG. 6 and in FIG. 7 there is a need of evaluating the values of four constant values in a linear approximation, namely;

for 0-point (f.0) ZERO₀ or ZERO_{ref};
a temperature coefficient “T_{Z}”; and

for discrepancy shown in FIG. 6;
SPAN₀ or SPAN_{ref};
a temperature coefficient “Tₛ”.

For 0-point evaluation the following formula is used;
ZERO(T)=ZERO₀+T_{Z}(T−T_{ref})=F(0)/f(OT)

For the descrepancy in FIG. 6 the following formula is used;
SPAN(T)=SPAN₀+T_{S}(T−T_{ref}).

In FIG. 7 it has been entered the storing sequence of successive values “M1”, “M2” and “Mmin” related to FIG. 2, however in this applicatoin the function “f(c)” is more or less inverse the graph illustration in FIG. 3.

It is shown in FIG. 6 a temperature correction to one and the same value for the zero concentration or 0-point of the CO₂-gas, where the A/D-converter counts to a count value and that value is calculated or transformed to a fixed value of 61440.

The graph “f(c,Ts)” in FIG. 6 shows the temperature-dependent absorption “a” at +5° C. and the absorption “a′” at +50° C., thus two different temperature curves, where the absorption rate is calculated as “1-transmission” and the “transmission” is adapted to constitute an A/D-converter related value, corresponding to “f(c,Ts)”/61440.

The two curves in the illustrated graph in FIG. 6 have been normalised (ZERO, Ts) to one and the same value (61440) for the A/D-converter, where said value is temperature compensated once as illustrated above.

FIG. 7 shows a graph or a final calibration table, which has been temperature corrected via a second or further temperature correction, applicable to the values obtained from or related to the A/D-converter as a function of the CO₂-concentration and where an A/D-converter value 58000, represented by the chosen CO₂-gas concentration of 400 ppm, has been chosen as a reference value or desired value, (Ref.).

More particularly, it is here a question of utilising the calibration curve “f(c)” at a chosen value for CO₂-concentration in order to obtain a reference value (Ref.) for the A/D-converter, where said reference value shall be lower than the 0-value of 61440.

This enables the digital A/D-converter-related values, above and below said reference value (Ref.) to be detected and stored and therewith enable a desired correction factor to be formed.

The calibration table according to FIG. 7 thus constitutes a function of or a combination of ZERO(T) and SPAN(T), where SPAN(T)=SPANo+Ts*T and where said calibration table is adapted for concerned measuring equipment.

FIG. 8 is a block diagram illustrating an alternative electronic circuit arrangement 6″ that includes electronic circuits and functions that mutually co-act in accordance with the inventions directives and which are based on the evaluation of the “highest” measurement value (See in FIG. 7) during a measuring cycle T1 while using a digital signal structure.

Such a “highest” value may be greater than or smaller than said reference value (Ref.) 61440 or conform to said reference value, in which situation the calculated correction factor “K1” shall not be changed.

When this applies to FIG. 6 or 7, the discrepancy occurring in dependence on chosen temperature values will be apparent.

With regard to the FIG. 8 embodiment, those blocks and functions that correspond to the blocks and functions shown in FIG. 2 have been identified with the same reference sign, although with the addition of a “prime” reference.

FIG. 8 illustrates a measuring gas detector 4′ that has a temperature correction and temperature compensating thermistor 8′ placed close to the detector 4′ in the gas sensor and its cavity 2″.

In the case of this embodiment, the detector 4′ delivers to an arrangement 6″ and a signal receiving circuit 60′ a gas sensor signal 4a′ and a temperature dependent signal 67a′(T), each analogue signal being converter in an A/D-converter, designated A/D.

These converted signals are coordinated for serial signal structure in a means, designated 60c′.

This circuit 60′ includes hardware and software for conditioning inputted analogue-related signals and adapt said signals to A/D-converters, that deliver a calculated value dependent on the signal structures received from said detector 4′ or said means 8′.

The circuit 60′ also performs a temperature compensation, in accordance with the conditions given with reference to FIG. 6.

The circuit 60′ sends a digital output signal to circuit 6a′, in which a further temperature compensation may be performed in accordance with the conditions shown in FIG. 7, together with a table conversion.

A measurement value presentation and a measurement value application are delivered to the presentation unit 7″ via the circuit 6a′.

The circuit 6a′ is also controlled by the correction signal “K1” from a circuit 63′ and 64′, representing a total compensation, wherein the circuit 67′ is in digital co-action with further two criteria.

The first criteria is controlled by the circuit 61′, which will note each increased value of the digital signal from the circuit 60′ while considering criteria dictated by the circuit 61a′ (M(t)).

This first criteria is dependent on the digital content of the memory or memory circuit 69′ (M(max)), the time circuit 66a′, the circuit 66′, the digital-signal-comparing circuit 62′, the digitally stored control value 65′, and a correction function circuit 63′.

The circuit 63′ co-acts with a circuit 64′ which, dependent on a correction mode in a circuit 68′, creates a “Category c” compensation factor “K1” applicable to a following time section “T2”.

The second criteria can be referred to “Category b” and “Category d” and constitutes a pressure compensation signal or some other compensation signal generated in the circuit 67c′

The third criteria refers to the use of a reference detector 5′ or some other gas detector (4″) which, similar to the measuring gas detector 4′, delivers a gas sensor signal (5a′or 4a′) and a temperature signal 67b′ (T) to a signal receiving circuit 60a′ or a similar circuit.

The total compensation evaluated and calculated in the circuit 67′ can be effected with the aid of simple algorithms.

The digitalised circuit arrangement, shown in FIG. 8, will thus differ somewhat from the circuit arrangement described above and illustrated in FIG. 2.

It is proposed that the expression “analogue-digital measurement value” shall imply a measurement value presented in analogue form, in accordance with FIG. 2 or a measurement value presented in digital form, in accordance with FIG. 8.

FIG. 9 is a graph showing the output signal related to said A/D-converters during a calibration sequence equal to what is shown in FIGS. 5 and 6.

The gas sensor arrangement, with a gas cell, light source, light receivers, a measuring path within a gas cell related cavity, electronic circuit arrangement is introduced in a clima chamber and at +5° C. and 0-content of CO₂ the counted number from the A/D-converter is read to 22000 (1).

The SPAN-GAS is introduced, here chosen as a concentration of 10000 ppm CO₂, and the counted number from the A/D-converted is read to 8000 (2).

The temperature in the clima chamber is raised to +50° C. and the A/D-converter is read to the same value 8000 (3).

The gas content within the chamber is raised to the same concentration as before, 10000 ppm CO₂, and the A/D-converter is read to 15000 (4).

As a control the temperature within the clima chamber is reduced to the reference temperature +25° C. and the A/D-converter is read (5), hopefully to the same value 15000 as under (4).

With this control it will be possible to evaluate the four constants mentioning above.

It will be apparent from FIG. 7 that at a discrepancy between a preferred value, (Ref: 58000) and a recorded value (Mₘᵢₙ 59000) this generates in circuits (64′a) compensating factor Ref/Mmin used for the succeeding time period used together with ZERO(T) and other possible compensating factors to adjust the A/D-converter related counter value towards the same preferred value (Ref. 58000).

It will be understood that the invention is not limited to the described and illustrated exemplifying embodiments thereof and that modifications can be made within the concept of the invention as illustrated in the accompanying claims.

It will noted in particular that each illustrated unit and/or function can be combined each other illustrated unit and/or function in order to achieve a desired technical function.

1. A method of compensating for measurement errors, primarily measurement errors included in the “drift” error source, with the aid of a gas sensor, wherein a plurality of measurement values occurring instantly during mutually sequential measuring cycles are detected, wherein;
a. storing a lowest or a highest measurement value or a measurement value close thereto, occurring and evaluated during a chosen time period (T1) in a memory (69,69′);
b. comparing said occurring and evaluated measurement value at the end of said chosen time period (T1) with a value selected from the group consisting of stored control value, set-point value and with a control value;
c. using a discrepancy between the evaluated and occurring measurement value with said value as a basis for a related and/or corresponding compensation of measurement values obtained and occurring in a following time period (T2) and by;
d. using a temperature sensing means, related to a gas cell (2), which generates a signal corresponding to the prevailing temperature, whereby said signal is feed to an electronic circuit arrangement (6), characterized by, that a signal from a gas cell related temperature sensing means (8) and duly received by said arrangement (6) is used to cause a temperature depending correction of each received signal from at least one or more light receiving means (4, 5) each related to said gas cell (2).

2. A method according to claim 1, characterized by, that said temperature depending correction is caused by a coordination of a number of temperature depending data, related to one and the same reference point.

3. A method according to claim 1, characterized by, that said electronic circuit arrangement (6) includes two circuits or the like for causing two signals.

4. A method according to claim 3, characterized by, that one signal is related to the measurement value, and one signal is related to the temperature value.

5. A method according to claim 4, characterized by, that said signal, related to the temperature, is used for a first temperature compensation and for a second temperature compensation.

6. A method according to claim 1, characterized by, including the gas sensor a cavity (2′) which is intended to enclose a volume of gas (G) to be measured, assigning to said gas sensor (2) a light source (3), which sends light beams through said cavity (2′) and also a light receiver (4), which receives said light beams after said beams have completed a chosen measuring path through said cavity; and by including an electronic circuit arrangement (6) with associated electronic circuits connected to said light source (3) and said light receiver (4) and adapted to evaluate the light intensity with respect to at least one wavelength related to the light beams sent from the light source (3) and to evaluate and calculate the presence of at least one gas and/or the concentration of such a gas.

7. A method according to claim 6, characterized by, decreasing or increasing analogue or digital evaluated measurement values for a measurement value compensation for values occurring within an immediately following measuring cycle (T2), and vice versa, in response to an occurring positive discrepancy.

8. A method according to claim 7, characterized by, adapting the stored analogue or digital control value or reference value to a chosen gas concentration, such as a concentration representative of a corresponding air-carried gas concentration.

9. A method according to claim 8, characterized by, generating an analogue or digital carbon dioxide control value, that lies within a concentration range of 350-450 ppm.

10. A method according to claim 6, characterized by, effecting necessary compensation dependent on a value appearing during a chosen measuring cycle (T1), by introducing a changed and corrected digital reference value obtained from an A/D-converter.

11. A method according to claim 10, characterized by, using as a compensation factor an A/D-converter setting at a normalized 0-value in respect of the gas used.

12. A method according to claim 1 characterized by, using a digital reference value, evaluated from a calibration table or calibration curve, and chosen to be lower or higher than a value referenced to a 0-value and therewith enable the creation of a digital correcting calibration.

13. A method according to claim 1 characterized by, causing the degree of compensation between mutually sequential measuring cycles to fall beneath a predetermined value.

14. A method according to claim 1, characterized by, storing a first measurement value in said memory, as a first analogue or digital measurement value, and replacing this first stored measurement value with an occurring lower or an occurring higher measurement value in said memory as a second digital measurement value.

15. An electronic circuit arrangement having a plurality of circuit arrangements for compensating measurement errors among other errors related to a “drift” error source, wherein measurements are effected with the aid of a gas sensor (2) for detecting a plurality of instantaneous measurement values during mutually sequential measuring cycles (T1), whereby measurement values, that lie close thereto and that occur and are evaluated during a chosen measuring cycle or time period (T1), are stored in a memory (69, 69′) as a measurement value via a first circuit arrangement (61, 61′); at the end of the chosen measuring cycle (T1) said occurring and evaluated measurement value is compared, via a second circuit arrangement (62, 62′), with a stored control value and that a discrepancy, established in a third circuit arrangement (63, 63′) between the evaluated measurement value and said stored control value, constitutes the basis of a compensation via a fourth circuit arrangement (64, 64′), of measurement values occurring within a following time period (T2) and using a temperature sensing means (8), related to a gas cell (2), which generates a signal corresponding to the prevailing temperature, whereby said signal is feed to said electronic circuit arrangement (6,6′), characterized by, a signal from a gas cell related temperature sensing means and duly received by said arrangement (6,6′) is used to cause a temperature depending correction of each received signal from at least one light receiving means (4, 5), each related to said gas cell (2).

16. An electronic circuit arrangement according to claim 15, characterized by, that said temperature depending correction is caused by a coordination of a number of temperature depending analogue or digital data, related to one reference point.

17. An electronic circuit arrangement according to claim 16, characterized by, that said electronic circuit arrangement (6, 6′) includes two circuits or the like for causing two independent signals.

18. An electronic circuit arrangement according to claim 17, characterized by, that one signal is related to the measurement value, one signal is related to the temperature value.

19. An electronic circuit arrangement according to claim 18, characterized by, that said signal, related to the temperature value, is used for a first temperature compensation or also for a second temperature compensation.

20. An electronic circuit arrangement according to claim 15, characterized by, in the event of a discrepancy in the comparison, the evaluated measurement values occurring in an immediately following measuring cycle or time period (T2) are compensated, such as either decreased or increased, via a fourth circuit arrangement (64, 64′).

21. An electronic circuit arrangement according to claim 15, characterized by, adapting said stored control value, via a fifth circuit arrangement (65′), to a chosen gas concentration.

22. An electronic circuit arrangement according to claim 21, characterized by, a control value, generated in respect of carbon dioxide via a fifth circuit arrangement (65′), lies within the range of 350-450 ppm.

23. An electronic circuit arrangement according to claim 15, characterized by, a chosen measuring cycle or time period is given a short or a long duration via a sixth circuit arrangement (66′).

24. An electronic circuit arrangement according to claim 23, characterized by, the time period achieved via said sixth circuit arrangement (66′) is longer than three calendar days and shorter than twenty calendar days.

25. An electronic circuit arrangement according to claim 15, characterized by, a chosen degree of compensation is dependent on further criteria, through the agency of a seventh circuit arrangement (67′).

26. An electronic circuit arrangement according to claim 15, characterized by, a chosen degree of compensation between mutually sequential measuring cycles is caused to lie beneath a predetermined value, through the agency of an eight circuit arrangement (68′).

27. An electronic circuit arrangement according to claim 15, characterized by, a first measurement value stored in said memory as a first analogue or digital measurement value via said first circuit arrangement; and by said stored first measurement value is replaced in response to the occurrence of another measurement value, which is therewith stored in said memory as a second digital measurement value, and so on.

28. An electronic circuit arrangement according to claim 15, characterized by, necessary compensation dependent on a lowest or highest value during a chosen measuring cycle is effected by introducing a changed analogue or digital reference value, said last mentioned reference value obtained from an A/D-converter.

29. An electronic circuit arrangement according to claim 28, characterized by, an A/D-converter setting is used directly or indirectly as a compensation factor related to a normalized 0-value.

30. An electronic circuit arrangement according to claim 15, characterized by, a used reference value (Ref.), evaluated from a calibration table or calibration curve (FIG. 7), is chosen to be lower than a value (61440) representing a 0-value so as to be able to create a corrective digitalized calibration above and beneath said reference value.
